(19) United States
(12) Patent Application Publication
(10) Pub. No.: US 2003/0192950 A1
(43) Pub. Date: Oct. 16, 2003

(54) PDA television module

(76) Inventor: Matthew Ward Muterspaugh, Indianapolis, IN (US)

Correspondence Address: JOSEPH S. TRIPOLI, THOMSON MULTIMEDIA LICENSING INC., 2 INDEPENDENCE WAY, P. O. BOX 5312, PRINCETON, NJ, 08543-5312, US

(21) Appl. No.: 10/121,405

(22) Filed: Apr. 12, 2002

(51) Int. Cl. G06K 7/10

(52) U.S. Cl. 235/472.01

(57) ABSTRACT

A plug-in module for a handheld personal computer includes a receiver for receiving television broadcasts and a processor coupled to the receiver and adapted to convert signals received by the receiver into a format capable of being displayed on a handheld personal computer. A mechanical interface of the module is configured and dimensioned to be received in an expansion slot of a handheld personal computer such that when coupled to the handheld personal computer a real-time television broadcast can be displayed on a display of the handheld personal computer.

### FIELD OF THE INVENTION

The present invention generally relates to consumer electronics equipment and, more particularly, to an accessory for use with a personal digital assistant (PDA) which provides television programs on the display of the PDA.

### BACKGROUND OF THE INVENTION

Handheld computers, or personal digital assistants (PDA's) have become increasingly more popular. An emerging feature of these devices is the ability to add modules that increase the functionality past the standard use of the PDA. These modules have included the functionality of a digital camera, a modem, paging modules, etc. PDA's are employed by users for a variety of tasks. These tasks include storing contact information, schedules/itineraries and other useful information. Because of the many functions of a PDA, users become reliant on carrying the PDA on their person. It would be advantageous to therefore provide increased capabilities for the PDA while using the capabilities already provided by the PDA.

It would therefore be advantageous to employ a module capable of receiving and playing television programs on a PDA screen.

### SUMMARY OF THE INVENTION

A plug-in module for a handheld personal computer includes a receiver for receiving television broadcasts and a processor coupled to the receiver and adapted to convert signals received by the receiver into a format capable of being displayed on a handheld personal computer. A mechanical interface of the module is configured and dimensioned to be received in an expansion slot of a handheld personal computer such that when coupled to the handheld personal computer a real-time television broadcast can be displayed on a display of the handheld personal computer.

A television system includes a handheld personal computer having an expansion slot and a display and a plug-in module dimensioned and configured to be received in the expansion slot. The module includes a receiver for receiving television broadcasts and a processor coupled to the receiver and adapted to convert signals received by the receiver into a format capable of being displayed on a handheld personal computer. An interface is adapted to communicate with the handheld personal computer such that when coupled to the handheld personal computer a real-time television broadcast is displayed on a display of the handheld personal computer.

### BRIEF DESCRIPTION OF THE DRAWINGS

The advantages, nature, and various additional features of the invention will appear more fully upon consideration of the illustrative embodiments now to be described in detail in connection with accompanying drawings wherein:

FIG. 1 is front view of an exemplary handheld computer in accordance with the prior art;

FIG. 2 is a bottom view of an illustrative expansion slot adapted to receive a module in accordance with one embodiment of the present invention;

FIG. 3 is a side view showing a handheld computer receiving a plug-in module in accordance with one embodiment of the present invention; and

FIG. 4 is a schematic block diagram showing a plug-in module in accordance with the present invention.

It should be understood that the drawings are for purposes of illustrating the concepts of the invention and are not necessarily the only possible configuration for illustrating the invention.

### DETAILED DESCRIPTION OF THE INVENTION

The present invention provides an apparatus, which improves the functionality of a personal digital assistant (PDA), hand-held computer or lap top computer. The present invention provides a plug-in module, which permits the PDA or other device to receive and display television programs. The present invention preferably takes advantage of the PDA's pixel display management capabilities, battery storage and memory to provide needed television without redundant hardware. Since a user typically carries a PDA, the user only needs to carry an additional plug-in television module to have television viewing capabilities.

It is to be understood that the present invention is described in terms of a personal digital assistant; however, the present invention is much broader and may include any handheld or portable computer device, which includes a display and is capable of receiving a television plug-in module. It should also be understood that the elements shown in the FIGS. may be implemented in various forms of hardware, software or combinations thereof. Preferably, these elements are implemented in a combination of hardware and software on one or more appropriately programmed general-purpose devices, which may include a processor, memory and input/output interfaces.

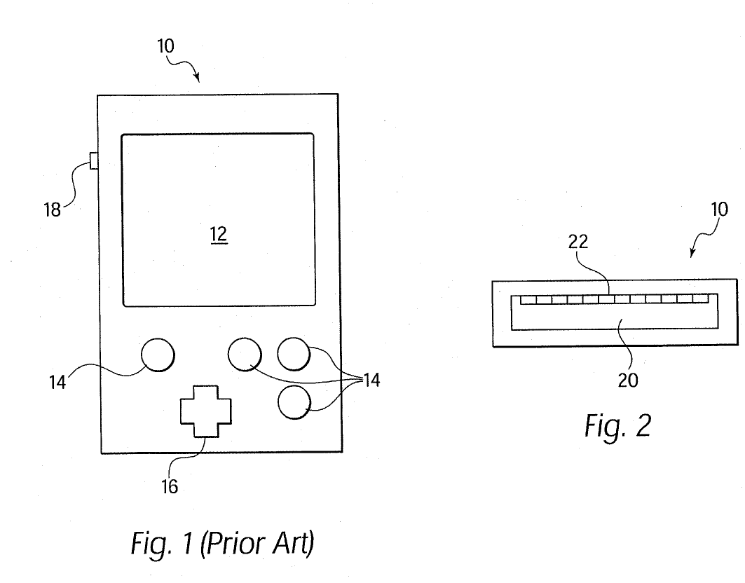

Referring now in specific detail to the drawings in which like reference numerals identify similar or identical elements throughout the several views, end initially to FIGS. 1 and 2, a personal digital assistant (PDA) 10 includes a display 12. Display 12 may include a liquid crystal display (LCD) or other display type. Display 10 includes pixels, which are driven by standard addressing and power circuitry. PDA 10 includes controls 14 and 16 to provide a way for a user to interface with PDA 10. Touch-screen display technology may also be provided with or without the use of a touch-screen pen. PDA 10 includes a switch 18 or other mechanism for powering-on the device. PDA 10 also includes battery power (not shown) for supplying power to PDA 10 when used remotely from a PDA base.

Details of PDA 10 are known to those skilled in the art, and will be described in details sufficient for an understanding of the present invention. PDA 10 includes a processor, memory and an operating system, which are to be compatible with the television module of the present invention, which will be described in detail hereinafter.

Since different brands and models of PDA's/handheld computers exist with different operating systems, expansion slots, and screens, television modules of the present invention need to be made compatible. For example, some PDA screens have far fewer pixels than standard analog televisions, and many are black-and-white only. Specific models of television modules in accordance with the present invention may be needed for each type of handheld computer. A few useful specifications for the handheld computer device may include: the size and type of expansion slots 20 of PDA 10 (standard, non-standard, etc.), screen size and the number of pixels (such that down-converting of a standard analog television signal is possible), external speakers or audio out plug (may be included on the module of the present invention if not included on the handheld computer device), color screen or black-and-white display, the operating system used, the speed of data transfer in expansion slot, the screen refresh rates/video update rates, etc. Other considerations are understood by those skilled in the art.

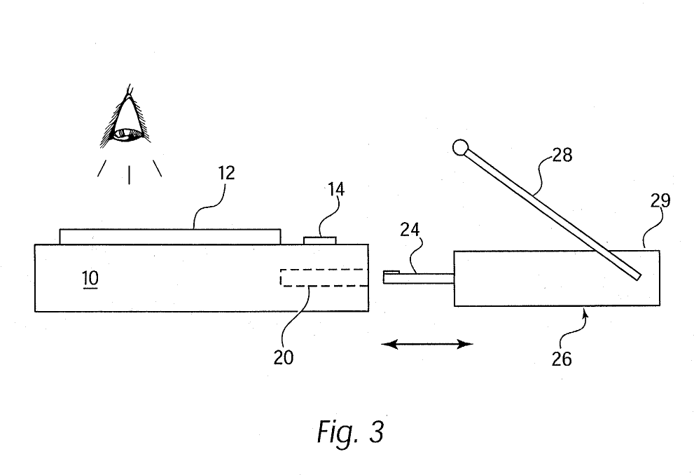

Referring to FIG. 2, an illustrative expansion slot 20 is shown. Expansion slot 20 includes contacts 21 which connect to a television module 26 (FIG. 3) in accordance with the present invention. Since slot 20 is preferably a slot in compliance with industry standards; however non-standard slots may be employed to accommodate specific features of module 26.

Referring to FIG. 3, a detachable television module 26 is illustratively shown in accordance with the present invention. Module 26 includes an interface 24 which is configured to be received in slot 20 of PDA 10. Module 26 includes a retractable and/or telescoping antenna 28, which is employed in receiving television program transmissions. When installed in PDA 10, module 26 receives a television signal and processes the signal to make the signal compatible with PDA 10. The signals are transferred to PDA 10 and displayed on display 12 of PDA 10 by employing the circuitry and software of PDA 10 to manage and address the pixels in display 12.

Module 26 includes a rigid housing 29, which may be manufactured in a plurality of different colors. Housing 29 preferably has a depth and width approximately equal to or smaller than the size of PDA 10, although other dimensions are also contemplated. It is preferably to have the length of housing 29 be approximately the same as the length of PDA 10.

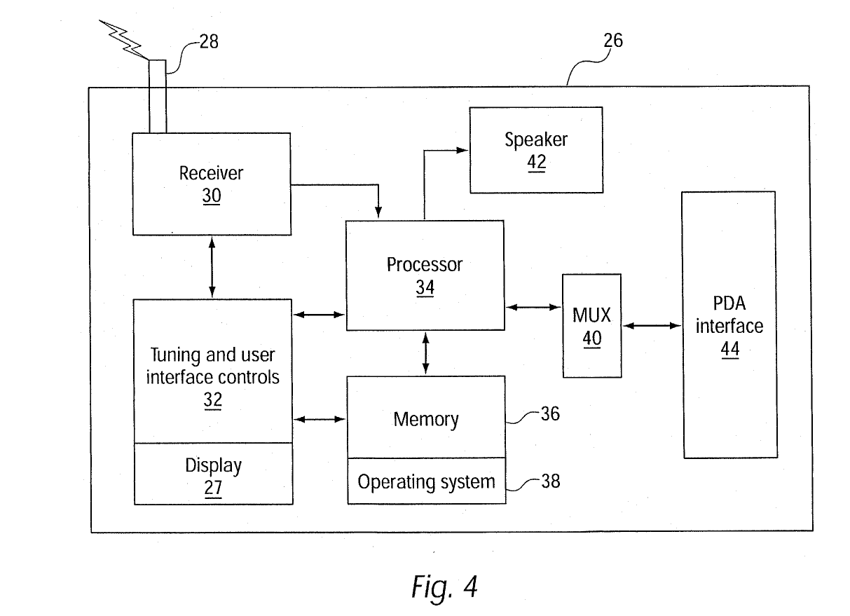

Referring to FIG. 4, a schematic block diagram is shown for module 26 in accordance with one embodiment of the present invention. The present invention employs technology used in creating miniature televisions (e.g., 2″ LCD-type televisions) for a television-receiver 30. Receiver 30 receives broadcast television signals via antenna 28, which is preferably a telescoping or adjustable antenna. Signals are selected by adjusting a tuner 32. Module 26 may also include a display 27 for indicating a television channel, time of day, modules settings or any other useful information. Alternately, tuning and other functions may be adjusted and controlled using controls 14 and 16 (FIG. 1) on PDA 10. Receiver 30 preferably employs standard television protocols for receiving, descrambling and/or decoding the received signals.

PDA display 12 may include a simple pixel screen, for example, a 160×160 pixel screen in 16 shades of grayscale. The refresh rate should be sufficient to reproduce the television signal at a viewable rate. In one illustration, considering a DRAM cycle takes about 5 clocks, and a few instructions in DRAM are also needed to make a tight loop, about 20 clocks or so may be needed to move 2 bytes. 20 clocks at, say, 16 MHz would be about 1.2 microseconds. At that rate, about 833 kHz transfers can be performed, or about 1.6 Mbytes per second. Refresh rates of greater than 16 MHz are contemplated. In addition, color pictures and higher definition displays are also contemplated.

Receiver 30 is coupled to a processor 34, which provides digital signal processing, filtering, and/or other signal conditioning functions. Processor 34 also converts the signals received from receiver 30 into a format compatible with an interface 44 to PDA 10. The signal output from interface 44 needs to be compatible with PDA pin assignments and number, the refresh rate of the PDA display 12 and the operating system of the PDA 10. Data received from a television broadcast may be stored in memory 36 and subsampled to provide the appropriate downconversion to the PDA display 12. It is contemplated that pixel resolution and/or refresh rates will be reduced to accommodate some PDA displays.

Processor 34 preferably includes one or more semiconductor chips which run software, process signals, etc. Processor 34 employs an operating system 38 resident in memory 36 to perform software functions and data interactions. Operating system 38 is preferably compatible with the operating system of PDA 10. In one embodiment, operating system 38 includes a partial operating system with features needed for module 26, namely signal processing and data storage for television signals.

Processor 34 outputs processed signals to a multiplexer/demultiplexer 40 for transfer to interface 44. A speaker 42 may be provided on module 26, if not already provided on PDA 10, to acoustically render the audio from the broadcast television signals. Alternately, a headphone plug may be employed instead of speaker 42. User controls 32 may include a volume control for speaker(s) 42. In addition, controls 32 may include a power on/off switch and a tuner for a radio application. Module 26 may be equipped with a radio tuner 32 and receive radio signals at receiver 30 from antenna 28. The radio signals are processed in processor 34 and are output at speaker 42.

PDA interface 44 is preferably compatible with standard PDA module slots. For example, interface 44 is compatible with PCMCIA-type module-slots. These are not compatible with all PDA devices; however PDA 10 and interface 44 may be selected for compatibility. Other types of expansion slots may be employed. In other embodiments, tuning and other user controls may be provided by using display 12 of PDA 10 (e.g., using touch-sensitive screen, keyboard, or buttons to control tuning and volume).

Having described preferred embodiments for PDA television module (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. Having thus described the invention with the details and particularity required by the patent laws, what is claimed and desired protected by Letters Patent is set forth in the appended claims.

What is claimed is:

1. A plug-in module for a handheld personal computer comprising:
a receiver for receiving television broadcasts;
a processor coupled to the receiver and adapted to convert signals received by the receiver into a format capable of being displayed on a handheld personal computer; and
a mechanical interface configured and dimensioned to be received in an expansion slot of a handheld personal computer such that when coupled to the handheld personal computer a real-time television broadcast is displayed on a display of a handheld personal computer.

2. The module as recited in claim 1, further comprising a speaker coupled to the processor to acoustically render audio of the television broadcast.

3. The module as recited in claim 1, further comprising a tuner coupled to the receiver for adjusting channels to receive the television broadcast.

4. The module as recited in claim 1, further comprising memory coupled to the processor to buffer data to permit a refresh rate for a display on the handheld personal computer.

5. The module as recited in claim 1, further comprising an operating system for the processor which is adapted to interact with an operating system of the personal handheld computer.

6. The module as recited in claim 1, wherein the mechanical interface is configured to be attached and detached from the expansion slot of the handheld personal computer.

7. The module as recited in claim 1, further comprising a display, which outputs information.

8. The module as recited in claim 1, further comprising user interface controls to provide at least one of tuning the receiver, programming the module and adjusting volume of a speaker.

9. The module as recited in claim 1, wherein the receiver includes a radio receiver for receiving radio broadcasts.

10. A television system, comprising:
a handheld personal computer having an expansion slot and a display;
a plug-in module dimensioned and configured to be received in the expansion slot, the module further comprising:
a receiver for receiving television broadcasts;
a processor coupled to the receiver and adapted to convert signals received by the receiver into a format capable of being displayed on the handheld personal computer; and
an interface adapted to communicate with the handheld personal computer such that when coupled to the handheld personal computer a real-time television broadcast is displayed on the display of the handheld personal computer.

11. The system as recited in claim 10, further comprising a speaker coupled to the processor to acoustically render audio of the television broadcast.

12. The system as recited in claim 10, further comprising a tuner coupled to the receiver for adjusting channels to receive the television broadcast.

13. The system as recited in claim 10, further comprising memory coupled to the processor to buffer data to permit a refresh rate for a display on the handheld personal computer.

14. The system as recited in claim 10, further comprising an operating system for the processor, which is adapted to interact with an operating system of a personal handheld computer.

15. The system as recited in claim 10, wherein the interface is mechanically configured to be attached and detached from the expansion slot of the handheld personal computer.

16. The system as recited in claim 10, further comprising a display, which outputs information.

17. The module as recited in claim 10, further comprising user interface controls to provide at least one of tuning the receiver, programming the module and adjusting volume of a speaker.

18. The module as recited in claim 10, wherein the receiver includes a radio receiver for receiving radio broadcasts.
